(19) United States
(12) Patent Application Publication
(10) Pub. No.: US 2015/0213467 A1
(43) Pub. Date: Jul. 30, 2015

(54) METADATA RICH TAG FOR SURVEY RE-TARGETING

(71) Applicant: Apple Inc., Cupertino, CA (US)

(72) Inventors: Mehul K. Sanghavi, Sunnyvale, CA (US); Sagar A. Joshi, San Jose, CA (US)

(73) Assignee: Apple Inc., Cupertino, CA (US)

(21) Appl. No.: 14/166,001

(22) Filed: Jan. 28, 2014

(51) Int. Cl. G06Q 30/02

(52) U.S. Cl. CPC G06Q 30/0203

(57) ABSTRACT

A user account can be tagged with a metadata rich survey tag used to manage a survey campaign. The survey tag can identify a user as eligible to participate in a survey campaign and include information used to manage the survey campaign. For example, the survey tag can include interaction data, survey affinity data, user demographic data, etc. The survey campaign can be managed according to survey campaign delivery parameters that dictate when to present a survey based on the metadata included in the survey tag. The survey campaign delivery parameters can be set to maximize invitational content item revenue by increasing the efficiency of the survey campaign, while still meeting survey campaign goals. The survey campaign delivery parameters can also be varied based on whether the survey campaign is on schedule to meet the survey campaign goals.

### TECHNICAL FIELD

The present technology pertains to re-targeting users to receive a survey, and more specifically pertains to a metadata rich survey tag for re-targeting a user to receive a survey.

### BACKGROUND

Invitational content providers, such as advertisers, spend a great deal of money on online advertising campaigns that advertise their services, products, business, etc. Gauging the effectiveness of these online campaigns is important to advertisers to determine the return on their monetary investment. The effectiveness of some online advertising campaigns can be easily gauged. For example, advertisements that enable a user to immediately purchase an advertised item can be gauged by the number of purchases resulting directly from the advertisements.

The effectiveness of other online advertisement campaigns, however, may not be as easy to monetize. For example, the effectiveness of an advertisement campaign meant primarily to increase brand recognition cannot easily be connected to an increase in sales. To gauge the effectiveness of these types of online advertising campaigns, advertisers often rely on surveys to gather feedback from users to determine the effect, if any, that the online advertising campaign had on the users.

To identify users that should be presented with a survey, current systems place a cookie on the user's client device after presenting the client device with an advertisement. Future content requests received from the client device can include the cookie, which indicates that the client device has been presented with the advertisement and thus is a candidate to receive a survey. While this system identifies users that have been presented with the advertisement, and thus can be served a survey, no further information is provided. Accordingly, an improved system is needed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for utilizing a metadata rich survey tag to manage a survey campaign. A survey campaign can include presenting surveys to gather user feedback in regards to a specified topic. A user's profile can be tagged with a survey tag to indicate that the user is eligible to participate in a survey campaign. The survey tag can include a survey campaign identifier identifying the specified survey campaign the user is eligible to participate in. Upon receiving a content request, the user account associated with the content request can be checked for a survey tag to determine whether the user has been marked as eligible to participate in the survey campaign. If the user account is tagged with a survey tag, a survey can be presented to the user in response to the content request.

The survey tag can also include interaction data describing the user's level of interaction with a specified invitational content item. This can indicate whether or not a user was presented with an invitational content item, whether the user interacted with the invitational content item and the level of the interaction with the content item, such as whether the user selected or clicked the invitational content item, interacted with a secondary view of the invitational content item, the exposure time during which the user was presented with or interacted with the invitational content item, etc.

The survey tag can also include data describing the user, such as demographic data describing the user's age, location, sex, etc. Alternatively, the demographic data can identify a predetermined demographic group the user belongs to, such as males between the ages 18-35.

The survey tag can also include survey affinity data describing the user's affinity towards surveys. For example, the survey affinity data can indicate the likelihood that the user will successfully complete a survey. The survey affinity data can also describe the user's preferences for different types of surveys. For example, the survey affinity data can indicate the user's preferences for surveys based on survey length, content, use of images, etc. The survey affinity data can be determined based on an analysis of the user's previous user interactions with surveys.

The survey tag can also include user preference data. For example, the survey tag can include user preference data describing the user's preferences for specified invitational content items, invitational content item providers, types of invitational content items, etc.

A survey campaign can be managed according to survey campaign delivery parameters that dictate when to deliver surveys based on metadata included in the survey tag. For example, the survey campaign delivery parameters can dictate which version of a survey is presented to a user based on the survey tag. A survey campaign can include multiple version of a survey and the campaign delivery parameters can dictate that the version of the survey presented to a user be selected based on the demographic group or survey preferences of the user.

In some embodiments, the survey campaign delivery parameters can dictate whether a survey or an invitational content item should be presented in response to a content request. For example, the survey campaign delivery parameters can dictate that surveys only be presented to users that are likely to successfully complete the survey. This can increase the efficiency of the survey campaign by minimizing the number of surveys that need to be presented to reach a specified survey campaign goal. Increasing the efficiency of the survey campaign can decrease the number of surveys that need to be presented to meet the survey campaign goal, resulting in an increase in the number of invitational content items that can be presented, and maximizing the revenue received from invitational content campaigns.

In some embodiments, the survey campaign delivery parameters can be variable based on whether the survey campaign is on schedule to meet specified survey campaign goals. For example, upon a determination that a survey campaign goal is not on schedule to be successfully met, the survey campaign delivery parameters can be varied to increase the completion rate of the surveys. For example, the survey campaign delivery parameters can be adjusted to give presenting a survey a higher priority that presenting an invitational content item when a content item is received from a user that is likely to successfully complete a survey.

If the survey campaign goals include multiple goals based on user category, the survey campaign delivery parameters can be varied to increase the completion rate of surveys for any individual user category that is not on schedule to meet the specified campaign goal. For example, a survey campaign goal can require that 100 surveys be successfully completed by users that were presented with an invitational content item and 100 surveys be completed by users that were not presented with the invitational content item. If it is determined that the campaign goal in regards to users that were presented with the invitational content item is behind schedule, the survey campaign delivery parameters can be modified to increase the completion rate of only that specified segment of users rather than all users.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 shows an exemplary method embodiment of tagging a user account with a survey tag;

FIG. 3 shows an exemplary method embodiment of managing a survey campaign using a survey tag; and

FIGS. 4A and 4B show exemplary possible system embodiments

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for utilizing a metadata rich survey tag to manage a survey campaign. A survey campaign can include presenting surveys to gather user feedback in regards to a specified topic. A user's profile can be tagged with a survey tag to indicate that the user is eligible to participate in a survey campaign. The survey tag can include a survey campaign identifier identifying the specified survey campaign the user is eligible to participate in. Upon receiving a content request, the user account associated with the content request can be checked for a survey tag to determine whether the user has been marked as eligible to participate in the survey campaign. If the user account is tagged with a survey tag, a survey can be presented to the user in response to the content request.

The survey tag can also include interaction data describing the user's level of interaction with a specified invitational content item. This can indicate whether or not a user was presented with an invitational content item, whether the user interacted with the invitational content item and the level of the interaction with the content item, such as whether the user selected or clicked the invitational content item, interacted with a secondary view of the invitational content item, the exposure time during which the user was presented with or interacted with the invitational content item, etc.

The survey tag can also include data describing the user, such as demographic data describing the user's age, location, sex, etc. Alternatively, the demographic data can identify a predetermined demographic group the user belongs to, such as males between the ages 18-35.

The survey tag can also include survey affinity data describing the user's affinity towards surveys. For example, the survey affinity data can indicate the likelihood that the user will successfully complete a survey. The survey affinity data can also describe the user's preferences for different types of surveys. For example, the survey affinity data can indicate the user's preferences for surveys based on survey length, content, use of images, etc. The survey affinity data can be determined based on an analysis of the user's previous user interactions with surveys.

The survey tag can also include user preference data. For example, the survey tag can include user preference data describing the user's preferences for specified invitational content items, invitational content item providers, types of invitational content items, etc.

A survey campaign can be managed according to survey campaign delivery parameters that dictate when to deliver surveys based on metadata included in the survey tag. For example, the survey campaign delivery parameters can dictate which version of a survey is presented to a user based on the survey tag. A survey campaign can include multiple version of a survey and the campaign delivery parameters can dictate that the version of the survey presented to a user be selected based on the demographic group or survey preferences of the user.

In some embodiments, the survey campaign delivery parameters can dictate whether a survey or an invitational content item should be presented in response to a content request. For example, the survey campaign delivery parameters can dictate that surveys only be presented to users that are likely to successfully complete the survey. This can increase the efficiency of the survey campaign by minimizing the number of surveys that need to be presented to reach a specified survey campaign goal. Increasing the efficiency of the survey campaign can decrease the number of surveys that need to be presented to meet the survey campaign goal, resulting in an increase in the number of invitational content items that can be presented, and maximizing the revenue received from invitational content campaigns.

In some embodiments, the survey campaign delivery parameters can be variable based on whether the survey campaign is on schedule to meet specified survey campaign goals. For example, upon a determination that a survey campaign goal is not on schedule to be successfully met, the survey campaign delivery parameters can be varied to increase the completion rate of the surveys. For example, the survey campaign delivery parameters can be adjusted to give presenting a survey a higher priority that presenting an invitational content item when a content item is received from a user that is likely to successfully complete a survey.

If the survey campaign goals include multiple goals based on user category, the survey campaign delivery parameters can be varied to increase the completion rate of surveys for any individual user category that is not on schedule to meet the specified campaign goal. For example, a survey campaign goal can require that 100 surveys be successfully completed by users that were presented with an invitational content item and 100 surveys be completed by users that were not presented with the invitational content item. If it is determined that the campaign goal in regards to users that were presented with the invitational content item is behind schedule, the survey campaign delivery parameters can be modified to increase the completion rate of only that specified segment of users rather than all users.

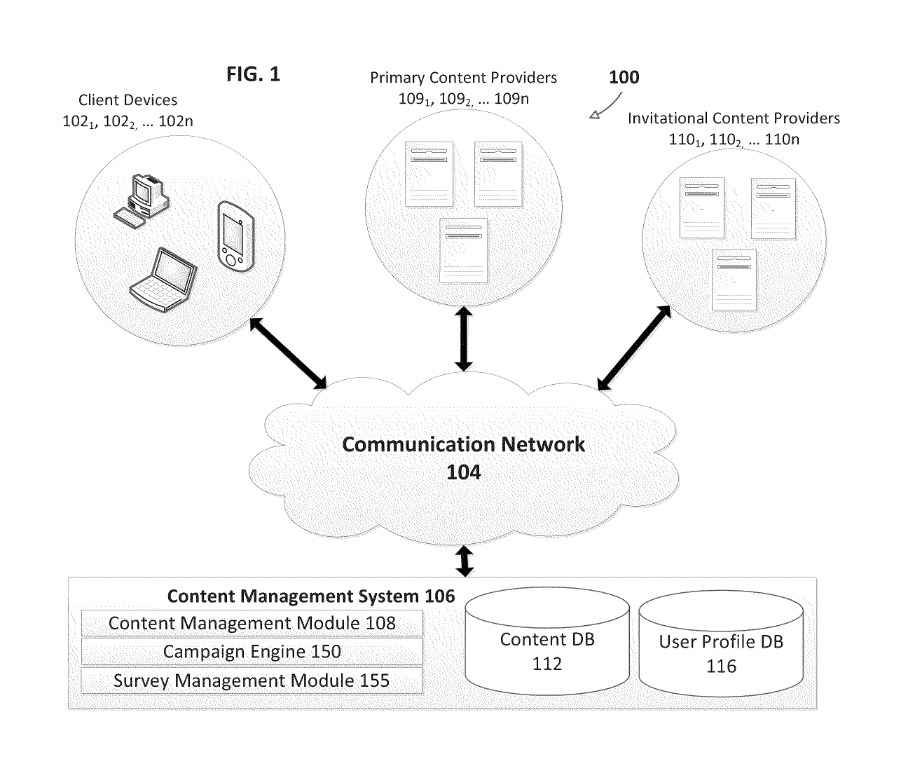

FIG. 1 illustrates an exemplary system configuration 100, wherein electronic devices communicate via a network for purposes of exchanging content and other data. As illustrated, multiple computing devices can be connected to communication network 104 and be configured to communicate with each other through use of communication network 104. Communication network 104 can be any type of network, including a local area network (“LAN”), such as an intranet, a wide area network (“WAN”), such as the internet, or any combination thereof. Further, communication network 104 can be a public network, a private network, or a combination thereof. Communication network 104 can also be implemented using any number of communications links associated with one or more service providers, including one or more wired communication links, one or more wireless communication links, or any combination thereof. Additionally, communication network 104 can be configured to support the transmission of data formatted using any number of protocols.

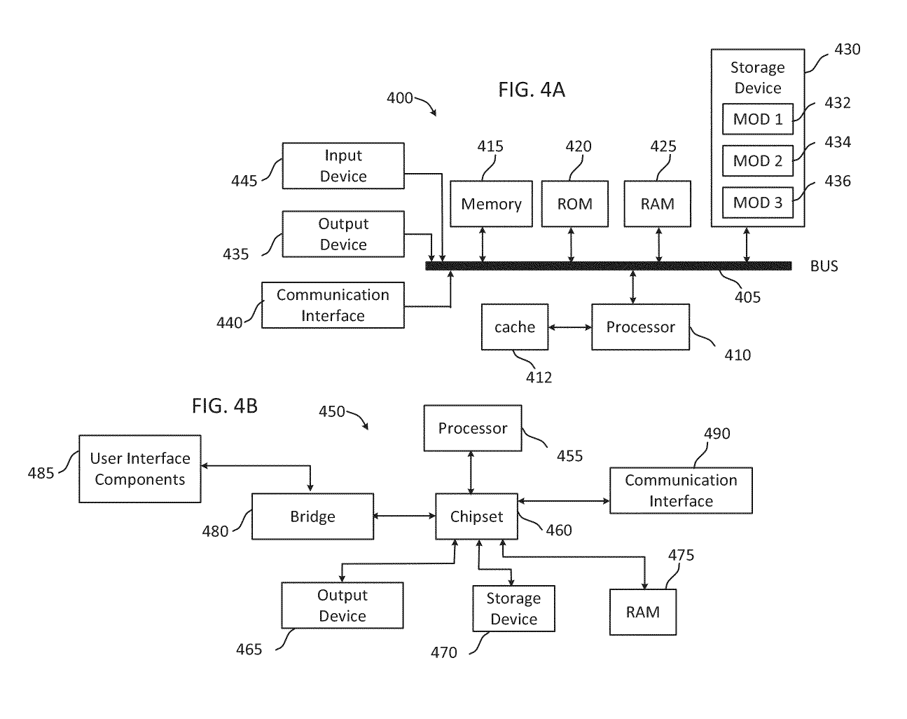

Multiple computing devices can be connected to communication network 104. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 400 of FIGS. 4A and 4B. To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

In system 100, invitational content is delivered to client devices 102₁ . . . 102ₙ (collectively “102”) connected to communication network 104 by direct and/or indirect communications with content management system 106. In particular, content management system 106 receives a request for a content package of electronic-invitational content, such as a web page, an application, a game, or media, etc., from one of client devices 102. In the various embodiments, one or more types of invitational content can be combined in a content package. Client devices 102 can be configured to render the received invitational content. This can include display or playing the invitational content appropriately depending on the form of the invitational content. For example, the invitational content can include text, graphics, audio, video, executable code or any combination thereof.

Upon successfully rendering the delivered invitational content, client devices 102 can be configured to send a notification to the content management system 106. In some embodiments the notification can be a web beacon such as an embedded tracking pixel. In some embodiments the operating system of the client devices 102 can be configured to report rendering of the invitational content. In some embodiments, the notification can be cryptographically secured by means such as authentication and digests.

In some embodiments, the invitational content can be associated with a product or can directly or indirectly advertise a product. In some embodiments, the content package can be configured to replace or update invitational content in a content package already delivered to the user terminal.

Further, the invitational content can be active invitational content. That is, invitational content that is designed to primarily elicit a pre-defined response from the user. For example, active invitational content can include one or more types of advertisements configured to be clicked upon, solicit information, or be converted by the user into a further action, such as a purchase or download of the advertised item. In some embodiments, active invitational content can include secondary views that can be presented to a user upon selection of an initial view of the invitational content. For example, the initial view can be a banner advertisement that, when selected, directs the user to a secondary view such as a multimedia advertisement.

However, invitational content can also include passive invitational content. That is, invitational content that is designed to primarily inform the user. In some cases, passive invitational content can include information that can lead or direct users to active invitational content. Additionally, the invitational content can be dynamic invitational content. That is, invitational content that varies over time or that varies based on user interaction with the invitational content. However, the various embodiments are not limited in this regard and the invitational content can be static invitational content that does not vary over time or that varies based on user interaction. In the various embodiments, an invitational content in a content package can be static or dynamic and active or passive. Further, various types of invitational content can be combined in a same content package.

After receiving the request for invitational content, content management system 106 selects the invitational content in response to the request and transmits the assembled invitational content to the requesting one of client devices 102. In some embodiments, content management system 106 has preselected the invitational content before the request is received. Thereafter, content management system 106 assembles a content package of invitational content and causes the content package to be delivered to the requesting one of client devices 102.

Content management system 106 can include content management module 108 that facilitates generation of the assembled content package, which can include invitational content. Specifically, content management module 108 can combine content from one or more primary content providers 109₁ . . . 109ₙ (collectively “109”) and content from one or more invitational content providers 110₁ . . . 110ₙ (collectively “110”) to generate the assembled content package for client devices 102. For example, in the case of a web page being delivered to a requesting one of client devices 102, content management module 108 can assemble a content package by requesting the data for the web page from one of primary content providers 109 maintaining the web page. For the invitational content on the web page provided by invitational content providers 110, content management module 108 can request the appropriate data according to the arrangement between primary and invitational content providers 109 and 110. In some embodiments, client devices 102 can directly request or already have access to primary content from primary content provider 109. In such embodiments, client devices 102 can further request invitational content from content management system 106. Content management system 106 can identify and deliver invitational content appropriate for association with primary content. For example, primary content, such as an application, can already reside or be running on one of client devices 102, and the primary content can direct the client device 102 to request invitational content from content management system 106 to be associated with primary content on the client device 102.

Although primary and invitational content providers 109 and 110 are presented herein as separate entities, this is for illustrative purposes only. In some cases, primary and invitational content providers 109 and 110 can be the same entity. Thus, a single entity can define and provide both the primary and the invitational content.

Although content management module 108 can be configured to request that content be sent directly from primary and invitational content providers 109 and 110, a cached arrangement can also be used to improve performance of content management system 106 and improve overall user experience. That is, content management system 106 can include content database 112 for locally storing/caching content maintained by primary and invitational content providers 109 and 110. The data in content database 112 can be refreshed or updated on a regular basis to ensure that the content in content database 112 is up-to-date at the time of a request from one of client devices 102. However, in some cases, content management module 108 can be configured to retrieve content directly from primary content provider 109 and invitational content provider 110 if the metadata associated with the data in content database 112 appears to be outdated or corrupted.

In some embodiments, the primary and invitational content can be assembled by client devices 102. For example, the primary content and invitational content can be delivered to one of client devices 102 and assembled at client device 102 based on assembly rules dictating how to properly assemble the primary and invitational content together. In some embodiment, the assembly rules can be delivered to client devices 102 by content management system 106.

In the various embodiments, content management system 106 can also include user profile database 116 that contains user profiles for various users. A user profile can store information regarding a user such as demographic data, personal data, interaction history, etc. A variety of session management techniques can be used to attribute client device interactions with a specified user account. For example, content management system 106 can implement an HTTP cookie or any other conventional session management method (e.g., IP address tracking, URL query strings, hidden form fields, window name tracking, authentication methods, and local shared objects) for client devices 102 connected to content management system 106 via a substantially persistent network session. However, other methods can be used as well. For example, in the case of handheld communications devices, such as mobile phones, smart phones, tablets, or other types of client devices connecting using multiple or non-persistent network sessions, multiple requests for content from such devices may be assigned to a single user account in user profile database 116. Content management system 106 can analyze the attributes of requesting client devices 102, including a Unique User Identifier (UUID), to determine whether such requests can be attributed to the same user account. Such attributes can include device or group-specific attributes.

Content management system 106 can include campaign engine 150, which can be configured to fulfill campaigns for content providers by managing inventory and pricing of invitational content items delivered to client devices 102. Content providers can arrange to have their invitational content delivered by content management system 106 based on a pricing scheme. For example, the pricing scheme can be arranged so that a content provider is charged a set price for each time an invitational content item is presented. Alternatively or additionally, a content item can be charged each time an invitational content item is selected.

A user selecting an invitational content item can include clicking an invitational content item presented on a client device through use of an input provided by the client device. For example, a user selecting an invitational content item can include a user clicking the invitational content item using a touchscreen of the client device displaying the invitational content item. Alternatively, a user selecting an invitational content item can include a user clicking the invitational content item using a mouse of the client device displaying the invitational content item.

Campaign engine 150 can be configured to record each time an invitational content item is presented and each selection received by an invitational content item, which can be used to calculate a cost accrued by the content provider for delivery of the invitational content items.

A content provider can arrange a campaign in any number of ways. In some embodiments, a content provider can choose a maximum spend limit for a period of time. For example a campaign can be configured so that the cost of delivering the invitational content does not exceed $10,000 over a month. In some embodiments the campaign can be configured to have a spend limit over a large time interval as well as another spend limit for a smaller time interval. For example, a campaign can be allocated to not exceed $10,000 over a month, but further not to exceed $500 in any given day. Campaigns can also be configured to have a minimum amount to be spent per specified time interval. For example, a campaign can have a daily max spend of $1,000 per day as well as a minimum spend of $950 per day. These examples are not meant to be limiting, campaigns can be configured in any number of ways known in the art.

Campaign engine 150 can be arranged to manage the delivery of the invitational content based on the parameters of the campaign. For example, if a content provider has arranged a maximum spend limit of $1,000 per day, campaign engine 150 can monitor the number of selections received by the invitational content item, and upon the spend limit of $1,000 being reached, no longer deliver the item of invitational content associated with the campaign. Rather, campaign engine 150 can select other invitational content items to deliver to a requesting one of client devices 102.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

While content management system 106 is presented with specific components, it should be understood by one skilled in the art that the architectural configuration of system 106 is simply one possible configuration and that other configurations with more or less components are also possible. For example, in some embodiments, content management system 106 can be configured to manage a survey campaign to presents surveys to client devices 102.

A survey campaign can be launched after or concurrently with an invitational content campaign to gauge the effectiveness of the invitational content campaign. This can include presenting surveys on client devices 102 to gather feedback in regards to a specified topic, such as an invitational content item, invitational content provider and/or invitational content campaign.

A survey can be any type of message designed to elicit a response indicating a user's preferences, opinion, etc., regarding a specified topic. For example, a survey can be a questionnaire regarding an invitational content provider such as an advertiser. The questionnaire can include questions designed to elicit a user to provide their opinion regarding the advertiser, such as whether the user views the advertiser and/or their products favorably, unfavorably, etc.

A survey can also be designed to enable a user to provide feedback. For example, the survey can include user interface elements, such as text boxes, buttons, checkboxes, etc., that enable a user to provide input indicating their response to any questions presented in the survey. A survey can also include a user interface element, such as a button, that when selected, can transmit the entered responses to content management system 106.

Content management system 106 can include survey management module 155 configured to manage a survey campaign. Survey management module 155 can utilize a metadata rich survey tag that can include metadata describing a user, invitational content item, invitational content provider, survey campaign, etc.

Survey management module 155 can be configured to tag a user profile with a survey tag, which can later be accessed to manage the survey campaign. For example, upon receiving a content request from client device 102ᵢ, survey management module 155 can identify the user profile associated with the content request and access the survey tag.

In some embodiments, the survey tag can identify a user as being eligible to participate in a survey campaign, meaning that the user is eligible to receive a survey as part of the survey campaign. For example, the survey tag can include a campaign identifier that identifies the survey campaign that the user is eligible to participate in. Survey management module 155 can retrieve the survey tag to identify a survey campaign, if any, that a user is eligible to participate in.

Survey management module 155 can identify a user as being eligible to receive a survey for any number of reasons. For example, survey management module 155 can identify users as eligible to participate in a survey campaign according to survey campaign delivery parameters.

The survey campaign delivery parameters can define conditions that must be met for a user to be eligible to participate in a survey campaign. For example, the survey campaign delivery parameters can dictate that a user account must have been presented with one or more specified invitational content items to participate in the survey campaign.

Alternatively, the survey campaign delivery parameters can dictate demographic conditions that must be met for a user to be eligible to participate in a survey campaign. For example, the survey campaign delivery parameters can dictate that users must be between 18-35 years of age to participate in the survey campaign. Upon identifying users that are eligible to participate in a survey campaign, survey management module 155 can tag the appropriate user account with a survey tag identifying the user as eligible to participate in the survey campaign.

In some embodiments, the survey tag can also include metadata describing invitational content items and the user's level of interaction with the invitational content items. For example, the survey tag can include one or more invitational content item identifiers that identify invitational content items. For example, the survey tag can include invitational content item identifiers identifying the invitational content items that the user has been presented with. Alternatively, the survey tag can identify the invitational content items associated with the survey campaign.

In addition to identifying an invitational content item, the survey tag can also identify the user's level of interaction with the invitational content item. For example, the survey tag can include interaction data describing whether or not the user was presented with the invitational content item.

Further, if the user was presented with the invitational content item, the interaction data can identify the extent of the user's interaction with the survey. This can include indicating whether the user selected or “clicked” the invitational content item, specific features or segments of the invitational content item selected, interaction with any secondary views of the invitational content item, the amount of time the user was exposed to and/or interacted with the invitation content item, etc.

In addition to identifying invitational content items the user has been presented with, the survey tag can also identify an invitational content item that the user should not be presented with. For example, a user can be designated as a member of a control group that should not be presented with the invitational content item. Feedback from the control group can be compared to feedback from users that were presented with the invitational content item to gauge the effectiveness so the invitational content item.

The survey tag can include data indicating that the user is a member of the control group for a specified survey campaign, and thus should not be served with any invitational content items associated with the survey campaign. Alternatively, the survey tag can identify the specific invitational content items the user should not be presented with.

In some embodiments, the survey tag can include survey affinity data describing the user's affinity in regards to surveys. For example, the survey affinity data can indicate the user's likelihood to complete a survey. Alternatively, the survey affinity data can indicate the user's preferences in regards to types of surveys. For example, the survey affinity data can indicate the likelihood that the user will complete a survey based on the length of the survey. Alternatively, the survey affinity data can indicate the likelihood that a user will complete a survey based on the types of questions presented in the survey. For example, a user may be more likely to complete a survey with questions including a visual portion, such as a picture of a product or trademark.

The survey affinity data can be based on previous user interactions in response to surveys presented to the user. For example, content management system 106 can monitor user interactions with each survey presented to the user, and log the interactions in the user's user profile. Survey management module 155 can be configured to analyze the logged user interactions to determine the survey affinity data, which can then be added to the survey tag.

For example, the logged user interactions can be analyzed to determine a percentage or proportion of the surveys presented to the user that were successfully completed. The survey affinity data can be based on this determined percentage. For example, the survey affinity data can identify the percentage of surveys the user has successfully completed. Alternatively, the survey affinity data can indicate a category or group that the user belongs to, such as users that complete 75% or more of the surveys presented to them, 25-50% of the surveys presented or less than 25%.

The survey affinity data can also be based on user provided preferences. For example, the users can set their preferences regarding surveys, including whether the user likes surveys, the types of surveys the user prefers, etc.

In some embodiments, the survey tag can include user demographic data describing a user. For example, the survey tag can identify a demographic group the user belongs to. Demographic data can include any data describing the user, such as age, location, sex, etc. The user demographic data can determined based on demographic data included in the user's user profile. The demographic groups can be based on predetermined demographic profiles as dictated by an invitational content provider.

In some embodiments, the survey tag can include user preference data indicating a user's preferences. For example, the user preference data can identify the user's preferences in regards to specified invitational content providers, products, etc. The user preference data can be gathered from the user's user profile. This can include gathering user preference data already stored in the user profile. This can also include deriving user preference data from the user's logged interactions with content management system 106. For example, user interactions with invitational content items can be analyzed to derive the user's preferences in regards to products, brands, etc. advertised by the invitational content items.

Survey management module 155 can manage a survey campaign according to survey campaign delivery parameters that dictate how, when and to who, survey are to be delivered based on metadata included in the survey tag. For example, the survey campaign delivery parameters can dictate the types of users that are eligible to participate in a survey campaign, when a survey should be delivered, which version of a survey should be delivered, as well can use the survey tags to manage the survey campaign. For example, upon receiving a content request from client device 102ᵢ, survey management module 155 can identify the user account associated with the content request, and then access the identified user account in user profile database 116. Survey management module 155 can then access any survey tag tagged to the user profile and use the tagged data to manage the survey campaign according to the survey delivery parameters. For example, the survey campaign parameters can dictate that survey management module 155 identify campaigns the user has been marked as eligible to participate in and then present the user with an appropriate survey in response to the content request.

In some embodiments, the survey delivery parameters can be set to increase the efficiency of the survey campaign and balance the objectives of meeting survey campaign goals and maximizing profit earned from invitational content campaigns.

Invitational content campaigns can include time based max spend limits which, if unmet, result in a loss of potential revenue from the invitational content campaign. For example, if the daily budget for an invitational content campaign is $100 and content management system 106 only serves $90 worth of impressions of the invitational content item, potential revenue of $10 is lost for that day.

To maximize profits, the survey campaign delivery parameters can be set to present invitational content items until the daily spend limits are met, after which, surveys can be presented. While this approach maximizes profit earned from the invitational content campaigns, it also increases the chances that survey campaign goals may not be met. For example, survey campaign goals may require that a specified number of surveys be completed within a specified amount time for the survey campaign to have an adequate sample size.

To balance these two goals, the campaign survey delivery parameters can be designed to use the survey tag to increase the efficiency of the survey campaign, meaning that the completion rate for presented surveys is increased. This can minimize the number of surveys that need to be presented to meet the survey campaign goals, thus maximizing the number of invitational content items that can be presented.

To accomplish this, the survey campaign delivery parameters can dictate that survey management module 155 use the survey tag to select a version of the survey that the user is most likely to complete. A survey campaign can include several different versions of a survey. For example, the survey campaign can include versions of a survey that differ based on length, content, types of questions, inclusion of images, etc.

Survey management module 155 can gather the survey affinity data included in the survey tag to determine the user's preferences regarding surveys and then select the version of the survey that the user is most likely to successfully complete. For example, if the survey affinity data indicates that the user is more likely to successfully complete a shorter survey that includes images, survey management module 155 can select a shorter version of the survey that includes images, thus increasing the likelihood that the user will successfully complete the survey. Alternatively, if the survey preference data indicates that the user is more likely to complete a longer survey, then survey management module 155 can select a longer version of the survey to present to the user.

The survey campaign delivery parameters can also dictate that survey management module use the survey tag to present surveys to users that are most likely to successfully complete the survey. For example, if the survey tag indicates that a user is likely to complete a survey, survey management module 155 can present the user with a survey rather than an invitational content item. Alternatively, if the user is determined to be unlikely to successfully complete the survey, survey management module 155 can present the user with an invitational content item rather than a survey.

In some embodiments, the survey campaign delivery parameters can be variable based on whether the survey campaign is on schedule to meet specified survey campaign goals. Survey management module 155 can be configured to monitor the performance of the survey campaign and then adjust the delivery parameters of the survey campaign based on the current performance. For example, survey management module 155 can manage a survey campaign according to survey campaign delivery parameters dictating that surveys only be presented after all invitational content campaign spends have already been met. Survey management module 155 can monitor the performance of the survey to determine whether the survey campaign is on track to meet the survey campaign goal. If the survey campaign is not on track to meet the survey campaign goals, i.e. the predetermined number of surveys will not be successfully completed in time; survey management module 155 can modify the survey campaign delivery parameters to ensure that the campaign goal is met. This can include presenting surveys to users that are likely to complete the survey, even if an invitational content campaign spend has not been met. Upon a determination that the survey campaign is back on track to meet the survey campaign goal, survey management module 155 can revert to managing the survey campaign according to the original survey campaign delivery parameters.

In some embodiments, survey campaign goals can include multiple goals based on type of users. The survey campaign goals can dictate various goals based on the level of interaction that a user had with one or more invitational content items, demographic profile, etc. For example, the survey campaign goals can require that 100 surveys be completed by users that were presented with a specified invitational content item but did not interact with the invitational content item, 100 surveys be completed by users that were presented with the specified invitational content item and also interacted with the invitational content item and 50 surveys be completed by users that were not presented with the invitational content item.

Survey management module 155 can be configured to vary the survey campaign delivery parameters to ensure that each of these individual goals is met. Survey management module 155 can monitor the number of surveys successfully completed by each type of user and vary the survey campaign delivery parameters for each type of user accordingly. For example, if it is determined that the number of surveys completed by users that were presented with and interacted with a specified invitational content item is below an desired amount, survey campaign module 155 can alter the campaign presentation delivery parameters for users that were presented with and interacted with the specified invitational content item to increase the number of surveys successfully completed.

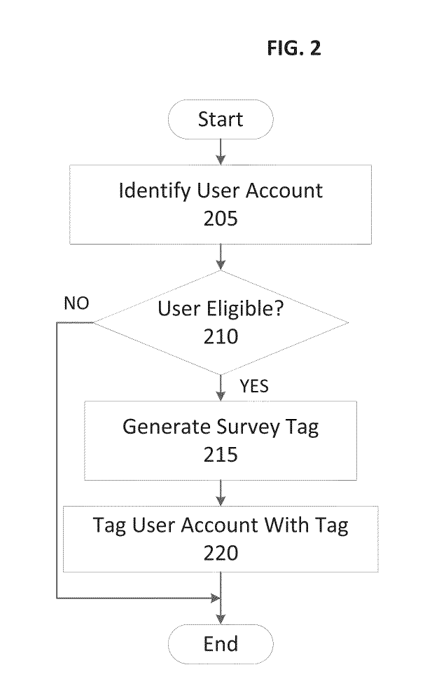

FIG. 2 shows an exemplary method embodiment of tagging a user account with a survey tag. As shown, the method begins at block 205 where a user account is identified. The method then continues to block 210 where it is determined whether the user associated with the user account is eligible to participate in a survey campaign. This can be determined based on survey campaign delivery parameters and user data stored in the user profile.

The survey campaign deliver parameters can dictate conditions that must be met for a user to be eligible to participate in the survey campaign. For example, the survey campaign delivery parameters can dictate demographic conditions that must be met for a user to be eligible to participate in the survey campaign. Alternatively, the survey campaign delivery parameters can dictate a required level of interaction with a specified invitational content item for a user to eligible to participate in the survey campaign.

The user data stored in the user profile can be analyzed to determine if the user meets the conditions set by the survey campaign delivery parameters. If the conditions are not met, then the user is determined to not be eligible to participate in the survey campaign and the method ends.

Alternatively, if the conditions are met, the user is determined to be eligible to participate in the survey campaign and the method continues to block 215 where a survey tag is generated for the user. The survey tag can identify the user as being eligible to participate in the survey campaign. For example, the survey tag can include a survey campaign identifier that identifies the survey campaign the user is eligible to participate in.

The survey tag can include further metadata describing the user, invitational content item, etc. The survey campaign delivery parameters can dictate data that should be included in the survey tag. This can include invitational content item identifiers, interaction data, survey preference data, user demographic data, etc. The required data can be gathered or derived from user data included in the user profile and then included in the survey tag.

At block 220 the generated survey tag is tagged to the user profile, where it can be accessed in the future. The method then ends.

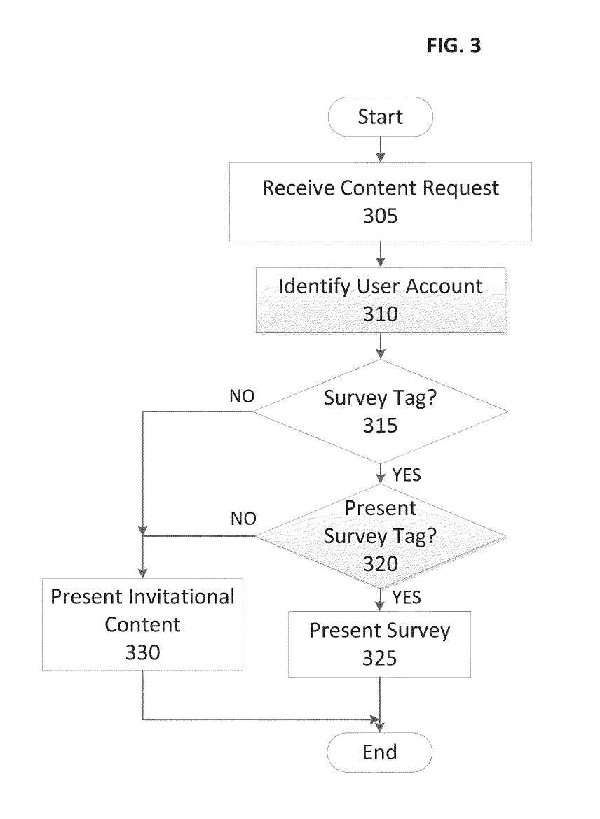

FIG. 3 shows an exemplary method embodiment of managing a survey campaign using a survey tag. As shown, the method begins at block 305 where a content request is received. A content request can be a request to present content, such as invitational content, primary content, etc., on a requesting client device.

Upon receiving the content re quest, the method continues to block 310 where a user account associated with the content request can be identified. This can be accomplished using any of a variety of methods. For example, the UUID associated with the requesting user device can be used to identify the user account. Alternatively, user credentials entered by the user can be used to identify the appropriate user account.

Upon identifying the user account, the method continues to block 315 where it is determined if the user account is tagged to the user account. If at block 315 it is determined that the user account is not tagged with a survey tag, the method continues to block 330 where an invitational content item is returned in response to the content request and the method ends.

Alternatively, if at block 315 it is determined that the user account is tagged with a survey tag, the method continues to block 320 where it is determined whether a survey be presented to the user in response to the content request. The determination can be made according to survey campaign delivery parameters that dictate whether a survey or invitational content item should be delivered. For example, the survey campaign delivery parameters can dictate conditions that must be met for a survey to be presented to a user, rather than an invitational content item.

The data included in the survey tag can be used to determine if the conditions are met. For example, the survey campaign delivery parameters can dictate that a first version of a survey should be presented to users in a first demographic group and a second version of the survey should be presented to users in a second demographic group. The metadata in the survey tag can be accessed to identify which demographic group the user belongs to. In some embodiments, the metadata can specifically identify whether the user belongs to the first or second demographic group. For example, the determination as to which demographic group the user belongs to can be made at the time the tag was generated and tagged to the user profile. Alternatively, the metadata can identify demographic data about the user and the data can be used to identify which of the demographic groups the user belongs to.

As another example, the survey campaign delivery parameters can dictate that a survey should be presented only if the user is likely to complete the survey. The survey affinity data in the survey tag can be accessed to determine if the user is likely to complete the survey. In some embodiments, the survey affinity data can include a group the user belongs to. For example, the user can be grouped as either likely to complete a survey or unlikely to complete a survey. In this type of scenario the grouping decision can be made at the time the survey tag was generated. Alternatively, the survey affinity data can include a value such as the percentage of surveys the user has successfully completed. The survey campaign delivery parameters can dictate a threshold value that the survey affinity value must exceed for the survey to be presented.

If at block 320 it is determined that a survey should not be presented, the method continues to block 330 where an invitational content item is returned in response to the content request and the method ends. Alternatively, if at block 320 it is determined that a survey tag should be presented, the method continues to block 325 where a survey is presented in response to the content request.

A survey can be presented in multiple ways. For example, a survey can be a standalone survey such as a pop-up survey, presented along with invitational content item. In some embodiments, the survey can be presented within or along with primary content. For example, the survey can be simply asking a user to present a rating for a book, article, etc. that a user was viewing. These are just a couple of examples of how a survey can be presented to a user and are not meant to be limiting. One skilled in the art would recognize that a survey can be presented in any of a variety of known ways in art and this disclosure contemplates all such embodiments. Upon presenting the survey, the method then ends.

FIG. 4A, and FIG. 4B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates a computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that exemplary systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving a content request associated with a first user account;
retrieving a survey tag tagged to the first user account, the survey tag including:
an interaction value indicating a level of interaction with a first invitational content item, and
a survey affinity value indicating a likelihood that a survey presented in response to a content request associated with the first user account will be successfully completed;
presenting, based on the interaction value and the survey affinity value, either a first survey regarding the first invitation content item or a second invitational content item, in response to the second content request.

2. The method of claim 1, further comprising:
presenting the first invitational content item in response to a second content request associated with the first user account, wherein the second content request is received prior to the first content request;
monitoring interaction with the first invitational content item presented in response to the second content request to determine the level of interaction to the first invitational content item.

3. The method of claim 1, further comprising:
prior to receiving the first content request, presenting a previous survey in response to a previous content request, the previous content request associated with the first user account; and
determining, the survey affinity value based on whether the previous survey was successfully completed.

4. The method of claim 1, wherein the presenting further comprises:
determining whether the survey affinity value is greater that a survey affinity threshold value;
when the survey affinity value is greater than a survey affinity threshold value, presenting the first survey regarding the first invitational content item in response to the second content request; and
when the survey affinity value is not greater than the survey affinity threshold value, presenting the second invitational content item in response to the second content request.

5. The method of claim 1, further comprising:
determining that the first content request is associated with the first user account from a first user identifier included in the first content request; and
determining that the second content request is associated with the first user account from a second user identifier included in the second content request.

6. The method of claim 5, wherein the first content request is received from a first client device and the second content request is received from a second client device, different than the first client device.

7. The method claim 1, wherein the presenting is further based on:
a target number representing a predetermined number of surveys regarding the first invitational content item that should have been presented at a time when the first content request was received to successfully satisfy a survey presentation goal of presenting a goal number of surveys regarding the first invitational content item prior to a target completion time; and
an actual number of surveys regarding the first invitational content item that have been presented at the time when the first content request was received.

8. The method of claim 7, wherein the presenting further comprises:
determining whether the actual number is greater than the target number;
when the actual number is not greater than the target number, presenting the first survey regarding the first invitational content item in response to the first content request; and
when the actual number is greater than the target number, presenting the second invitational content item in response to the first content request.

9. The method of claim 1, wherein:
the survey tag further includes a survey preference value indicating the likelihood that a survey longer than a predetermined length presented in response to a content request associated with the first user account will be successfully completed,
the presenting is further based on the survey preference value, and
the presenting further determines whether to present a second survey regarding the first invitation content item, in response to the first content request, wherein the second survey is longer than the first survey.

10. The method of claim 9, wherein the presenting further comprises:
determining whether the survey preference value is greater than a survey preference threshold value;
when the survey preference value is greater than the survey preference threshold value, presenting the second survey regarding the first invitational content item; and
when the survey preference value is not greater than the survey preference threshold value, presenting the first survey regarding the first invitational content item.

11. The method of claim 1, further comprising:
receiving a third content request, the third content request associated with a second user account, different than the first user account;
determining that the first invitational content item has not been presented in response to any previous content requests associated with the second user account;
tagging the second user account with a second survey tag, the second survey tag including:
a control group flag indicating that the first invitational content item should not be presented in response to any future content requests associated with the second user account, and
a survey affinity value indicating a likelihood that a survey presented in response to a content request associated with the second user account will be successfully completed; and
presenting a third invitational content item, different than the first invitational content item, in response to the third content request.

12. The method of claim 11, further comprising:
receiving a fourth content request, the fourth content request associated with the second user account; and
presenting, based on the control group flag, a fourth invitational content item, different than the first invitational content item, in response to the fourth content request.

13. A system comprising:
a processor; and
a memory containing instructions that, when executed, cause the processor to:
receive a content request associated with a first user account;
retrieve a survey tag tagged to the first user account, the survey tag including:
an interaction value indicating a level of interaction with a first invitational content item, and
a survey affinity value indicating a likelihood that a survey presented in response to a content request associated with the first user account will be successfully completed;
present, based on the interaction value and the survey affinity value, either a first survey regarding the first invitation content item or a second invitational content item, in response to the second content request.

14. The system of claim 13, wherein the instructions further cause the processor to:
present the first invitational content item in response to a second content request associated with the first user account, wherein the second content request is received prior to the first content request;
monitor interaction with the first invitational content item presented in response to the second content request to determine the level of interaction to the first invitational content item.

15. The system of claim 13, wherein the instructions further cause the processor to:
prior to receiving the first content request, present a previous survey in response to a previous content request, the previous content request associated with the first user account; and
determine, the survey affinity value based on whether the previous survey was successfully completed.

16. The system of claim 13, wherein the presenting further comprises:
determining whether the survey affinity value is greater that a survey affinity threshold value;
when the survey affinity value is greater than a survey affinity threshold value, presenting the first survey regarding the first invitational content item in response to the second content request; and
when the survey affinity value is not greater than the survey affinity threshold value, presenting the second invitational content item in response to the second content request.

17. The system of claim 13, wherein the instructions further cause the processor to:
determine that the first content request is associated with the first user account from a first user identifier included in the first content request; and
determine that the second content request is associated with the first user account from a second user identifier included in the second content request.

18. The system of claim 17, wherein the first content request is received from a first client device and the second content request is received from a second client device, different than the first client device.

19. The system claim 13, wherein the presenting is further based on:
a target number representing a predetermined number of surveys regarding the first invitational content item that should have been presented at a time when the first content request was received to successfully satisfy a survey presentation goal of presenting a goal number of surveys regarding the first invitational content item prior to a target completion time; and
an actual number of surveys regarding the first invitational content item that have been presented at the time when the first content request was received.

20. The system of claim 19, wherein the presenting further comprises:
determining whether the actual number is greater than the target number;
when the actual number is not greater than the target number, presenting the first survey regarding the first invitational content item in response to the first content request; and
when the actual number is greater than the target number, presenting the second invitational content item in response to the first content request.

21. A non-transitory computer-readable medium containing instructions that, when executed by a computing device, cause the computing device to:
receive a content request associated with a first user account;
retrieve a survey tag tagged to the first user account, the survey tag including:
an interaction value indicating a level of interaction with a first invitational content item, and
a survey affinity value indicating a likelihood that a survey presented in response to a content request associated with the first user account will be successfully completed;
present, based on the interaction value and the survey affinity value, either a first survey regarding the first invitation content item or a second invitational content item, in response to the second content request.

22. The non-transitory computer-readable medium of claim 21, wherein:
the survey tag further includes a survey preference value indicating the likelihood that a survey longer than a predetermined length presented in response to a content request associated with the first user account will be successfully completed,
the presenting is further based on the survey preference value, and
the presenting further determines whether to present a second survey regarding the first invitation content item, in response to the first content request, wherein the second survey is longer than the first survey.

23. The non-transitory computer-readable medium of claim 22, wherein the presenting further comprises:
determining whether the survey preference value is greater than a survey preference threshold value;
when the survey preference value is greater than the survey preference threshold value, presenting the second survey regarding the first invitational content item; and
when the survey preference value is not greater than the survey preference threshold value, presenting the first survey regarding the first invitational content item.

24. The non-transitory computer-readable medium of claim 21, wherein the instructions further cause the computing device to:
receive a third content request, the third content request associated with a second user account, different than the first user account;
determine that the first invitational content item has not been presented in response to any previous content requests associated with the second user account;
tag the second user account with a second survey tag, the second survey tag including:
a control group flag indicating that the first invitational content item should not be presented in response to any future content requests associated with the second user account, and
a survey affinity value indicating a likelihood that a survey presented in response to a content request associated with the second user account will be successfully completed; and
present a third invitational content item, different than the first invitational content item, in response to the third content request.

25. The non-transitory computer-readable medium of claim 24, wherein the instructions further cause the processor to:
receive a fourth content request, the fourth content request associated with the second user account; and
present, based on the control group flag, a fourth invitational content item, different than the first invitational content item, in response to the fourth content request.
